(19) United States
(12) Patent Application Publication
(10) Pub. No.: US 2008/0196672 A1
(43) Pub. Date: Aug. 21, 2008

(54) Metabolic Cage For Small Rodents

(75) Inventors: Armand Mokhtarian, Paris (FR); Patrick Even, Sceaux (FR)

Correspondence Address: Young & Thompson, 745 S. 23rd Street., Second Floor, Arlington, VA, 22202, US

(73) Assignee: Armand MOKHTARIAN, Paris (FR)

(21) Appl. No.: 11/994,171

(22) PCT Filed: Jun. 29, 2006
(86) PCT No.: PCT/FR2006/050652

§ 371 Date: Apr. 25, 2008

(30) Foreign Application Priority Data
Jun. 30, 2005 (FR) 05 51853

(51) Int. Cl. A01K 1/03

(52) U.S. Cl. 119/421; 119/417

(57) ABSTRACT

The invention concerns a metabolic cage (1) for small rodents, comprising: a living chamber (20) designed to receive a rodent; a technical mount (30), said living chamber (20) and said technical mount (30) comprising each complementary nesting elements, enabling the living chamber (20) to be assembled and released relative to the technical mount (30).

The present invention relates generally to a metabolic cage intended for small rodents. It relates more particularly to a modular metabolic cage, composed of a living chamber which may be fitted with different modules to suit the needs of the users.

The metabolic cages enable to study parameters which partake of the regulation of the energetic balance such as the food intake in the mouse, the rat, and the hamster.

The mouse is an excellent model to define the functions of the genes of mammals, since it exhibits great genetic, immunological, reproductive, physiological and pathological similarities with Man.

Consequently, genomic and proteomic studies showing the implication of the genes and proteins in different human pathologies has opened new therapeutic paths in biomedicine.

The function of the genes must be established not only at molecular level, but also in the animal. The tests of pharmaceutical compounds in preclinical study phase (pharmacology, toxicology) in vivo require physiological and behavioural phenotyping of the animal model used.

Phenotyping consists (i) in defining the whole of the functional characters, conditioned by the genetic patrimony of an individual and by its interaction with the medium, and (ii) in detecting variations relative to a standard. To perform these studies, metabolic cages are today used quite frequently.

More generally, the metabolic cages are also used quite frequently for biomedical research and the development of therapeutic compounds, as described above, but also to conduct phenotypic studies in development biology, neurosciences, cancerology or still for preclinical development of medications.

In all these domains, the important potential of the metabolic cages also lies in their non-invasive character which enables to track animals with time thanks to a repetitive observation of animals.

The metabolic cages are generally designed to provide a single possibly two types of measurements. There are thus metabolic cages intended for measuring the contents of urines and faeces of animals or still metabolic cages intended for measuring the energetic consumption by measuring respiratory exchanges.

Consequently, when a great variety of phenotypic measurements must be performed on an animal, two solutions are generally available. A first solution consists in using several metabolic cages, each being devolved to a particular type of measurement. This solution is however little satisfactory since it implies a multiplication of the number of necessary metabolic cages when conducting studies on a group of animals. A second solution consists in using more complex metabolic cages, equipped with a larger set of measuring elements, hence costly.

Consequently, there is a need for new metabolic cages, which may be suited easily to the needs of the users, and in particular which may be fitted with different measuring elements in relation to the complexity and the variety of the measurements to perform on the animal.

Another shortcoming of the conventional metabolic cages lies in the stress inflicted to animals before experimentation which causes time losses during tests.

For better reproducibility of the tests, in particular to minimise the stress of animals, and in order to reduce the immobilisation time of the test apparatuses coupled to the metabolic cages, between two experiments, it would be desirable to have improved metabolic cages, relative to those known.

The need for new metabolic cages, suitable to the constraints of the users is even more important as the phenotyping studies conducted on rodents, in constant development, make characterisation of pathogenic factors involved in numerous human pathological syndromes considerably easier.

The inventors have developed a metabolic cage complying with the needs described above. The present invention relates to a metabolic cage for small rodents including:
a living chamber designed to receive a rodent, said living chamber including lateral walls and a floor fitted with honeycombs enabling the evacuation of the urines and faeces by gravity, and
a technical mount including a funnel intended for receiving and separating said urines and faeces toward a vessel.

Said technical mount also includes at least one supporting part intended for receiving a module useful to the implemented of the metabolic cage, in particular for phenotyping of the small rodents.

Preferably, the technical mount includes 1, 2, 3, 4, 5 or 6 supporting parts, preferably from 1 to 4 supporting parts, each intended for receiving a module. According to the invention, said living chamber and said technical mount include each complementary nesting element, enabling the living chamber to be assembled and released relative to the technical mount.

In other words, said metabolic cage hence includes a first functional position wherein the technical mount is in contact with the floor of the living chamber and a second functional position wherein the technical mount is separated from the living chamber.

By “functional position”, is meant according to the present invention, a configuration wherein the rodent is present into the living chamber.

The living chamber may hence be separated from the technical mount when a rodent is present into the living chamber. This living chamber may be the permanent or transient housing of the animal, which may be installed on a simple mount, and be for instance stored individually or in a rack. This complete dissociation between the living chamber and the technical mount has multiple advantages.

Thus, a rodent may be placed in the living chamber for more or less long duration, defined by the user, before the living chamber does not come in contact with the technical mount, and measurements start.

In this manner, the animals benefit from an acclimatisation time period favourable to stress reduction, before the tests for the performance of which the living chamber is laid on a technical mount.

The users may thus have a number of living chambers greater than the number of technical mounts and/or of implementation modules, so that the use of the technical mount and of the implementation modules is optimised.

By “rodent” or “small rodent”, is meant according to the present invention a small-sized animal, and preferably, a mouse, a rat and a hamster.

In a preferred manner, the metabolic cage described above includes moreover, an actimetry platform situated in contact with the technical mount, including at least one sensor (41), preferably 1, 2, 3 or 4 sensors, selected among motion sensors, load sensors and weighing sensors, so as to measure the activity of the rodent.

Between two tests with a metabolic cage according to the invention, the living chamber (20), which contains at least one animal, is nested on a single mount, wherein said single mount may be fitted with a sensor (41).

An actimetry platform enables to measure the activity, in particular the movements of the rodent placed into the living chamber.

By way of example the load sensor, may be a piezoelectric type load sensor. In particular, weighing microsensors of the type implemented currently in the manufacture of precision scales may be used.

The actimetry platform described above may include for instance 3 or 4 sensors, so that the movements of the rodent may be analysed in detail. In particular, the use of 3 or 4 sensors enables to measure the position of the rodent within the living cage. The use of 3 or 4 sensors also enables to prevent the use of infrared beams, known to the man of the art, to define the position of the rodent into the cage.

Thus, the actimetry platform includes advantageously 1, 2, 3 or 4 piezoelectric sensors.

When solely the physical activity or the vigilance level must be measured, but not the position of the rodent, the use of a single sensor is sufficient.

In a particular embodiment of the invention, the metabolic cage includes a device for controlling the position of the small rodent in the living chamber by infrared beam.

Optionally, the metabolic cage may include moreover at least one implementation module whereof one of the side walls enables the communication with the volume formed by the living chamber, so that a rodent placed in said living chamber may access said module.

The metabolic cage as well the implementation modules, described above, have a suitable size according to the type of animal studied. For instance a small metabolic cage is used for studying a mouse, a medium size metabolic cage is used for studying a hamster, and a large metabolic cage is used for studying a rat.

By “access” to an implementation module, especially a trough module or a water supply module, the man of the art will understand that a rodent, placed in the living chamber may insert his head, the anterior part of his body in said module. A “sanctuary” module, especially designed for letting through the complete body of the animal may be fixed to the living chamber (20), in certain embodiments.

Preferably, said module is separated from the living chamber by a sealing opening. By way of example, the sealing opening may consist of a diaphragm or a sliding panel. Thus, access to the module may be controlled by the user.

Said module may include a solid or liquid food reserve, and in particular, a trough or a feeding-bottle. Said module may also be formed of a vessel delineating an empty space wherein the rodent may take refuge, for instance to sleep, access to said module being adapted to the size of the animal.

Preferably, the implementation modules comprising a solid or liquid food reserve include moreover a weighing sensor, so that it is possible to measure the food intake or the liquid intake of the animal. In other embodiments, in particular for the realisation of tests for which measuring the consumption of water and foodstuffs is not required, implementation modules fitted with a trough and/or a feeding-bottle may be used, which do not comprise any sensors, in particular weighing sensors.

The metabolic cage may include 1 to 6 implementation modules, advantageously from 1 to 4 modules, and preferably 1 or 2 implementation modules, said modules being identical or different from one another.

The arrangement of several types of modules thus enables the user to adapt the metabolic cage to the type of measurement that he wishes to perform. Having several types of modules enables for instance to test food choices of an animal or to perform aversion or learning tests which are well known to the man of the art, and which will not be described here in detail.

The use of 3 modules each including a trough enables for instance to measure respectively the amount of proteins, of lipids and of glucides consumed by the animal and to determine the sequence wherein these nutrients are ingested.

The living chamber includes a removable ceiling, which is optionally leak-proof. When the living chamber is leak-proof, the latter may include moreover, a device for measuring calorimetry, and in particular, a device for measuring respiratory exchanges.

By way of example, the device for measuring respiratory exchanges includes successively:
a fresh air supply means,
one or several fans situated in the metabolic cage, if needed in the removable ceiling (24), and/or in the implementation modules,
a means for evacuating vitiated air,
a means for measuring the ratio of O₂ and/or de CO₂ in vitiated air, and
a means for measuring the air flow through the metabolic cage.

Thus, when the metabolic cage includes both a module including solid or liquid food, and a device for measuring respiratory exchanges, the user may control a set of parameters which partake of the regulation of the energetic balance of the animal, and in particular the food intake and the energetic discharge. Moreover, when an actimetry platform (40) is used, the influence of the activity of the rodent in the energetic balance may be taken into account.

The volume of urines of the small rodents being rather small, the funnel intended for collecting the urines may be fitted with a moisturising device including a means for rinsing said funnel, enabling to optimise the collection of the urines.

By way of example, a water circulation closed circuit may be established between the funnel, and the vessel intended for collecting the urines and the faeces. To this end, distilled water is placed in the vessel intended for collecting the urines and the faeces. A pump, for instance a peristaltic pump may thus be added to the technical mount, close to the funnel, so as to pump the water contained in the vessel intended for collecting the urines and the faeces, water being then rejected in the upper section of the funnel, for the moisturising thereof.

According to an alternative embodiment, said vessel is replaced with a connector associated with the end of a tube, the other end of said tube is connected to a pump, said pump being in fluid communication with a collector vessel of fractions enabling to sample urines at determined instants.

The metabolic cage described above may include moreover one or several hydraulic and/or electric cables, reaching inside the living chamber, said cable(s) being intended for taking measurements on the rodent or for performing infusions or samplings.

The use of a cable enables for instance to withdraw blood samples from the rodent placed into the living chamber or still to inject a liquid thereto. The cable may also enable to perform electric stimulations of the rodent or records of physiological electric signals such as the arterial pressure, cardiac rhythm or neuronal activities, if the animal is fitted in advance for these measurements.

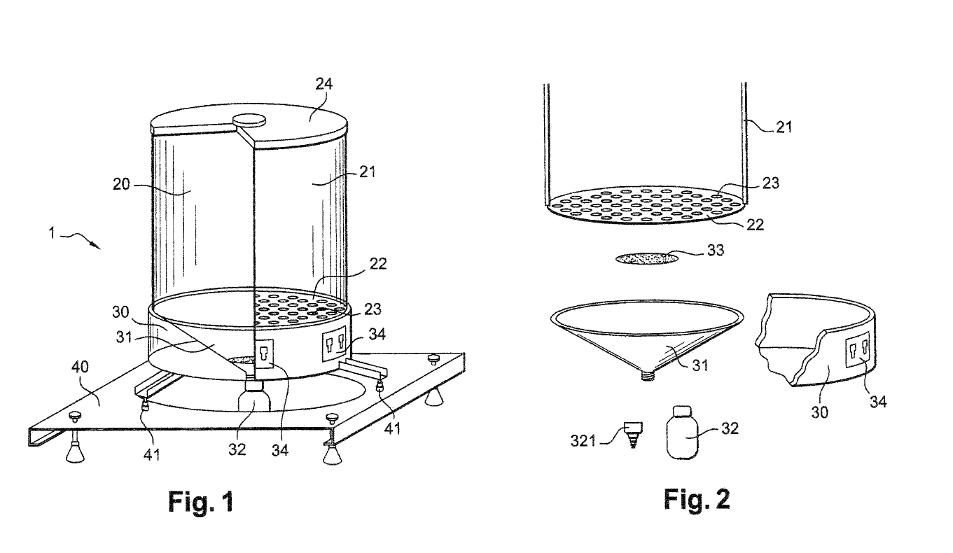

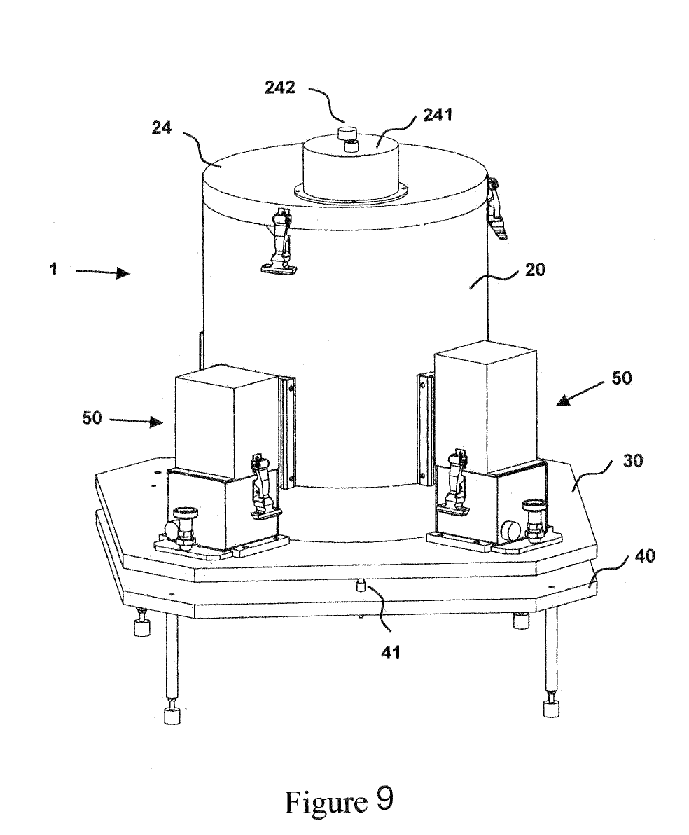

The description refers further to the appended figures. FIGS. 1 to 8 represent a general embodiment of a metabolic cage according to the invention. FIGS. 9 to 14 represent particular embodiments of the metabolic cage of the invention. FIGS. 1 to 14 represent, respectively:

FIG. 1: a general view of a metabolic cage 1, according to the invention, including a living chamber 20, a technical mount 30, and a supporting platform 40, rackable which, if it is fitted with load or weighing sensors becomes an actimetry platform 40.

FIG. 2: an exploded view of the inside of the technical mount 30,

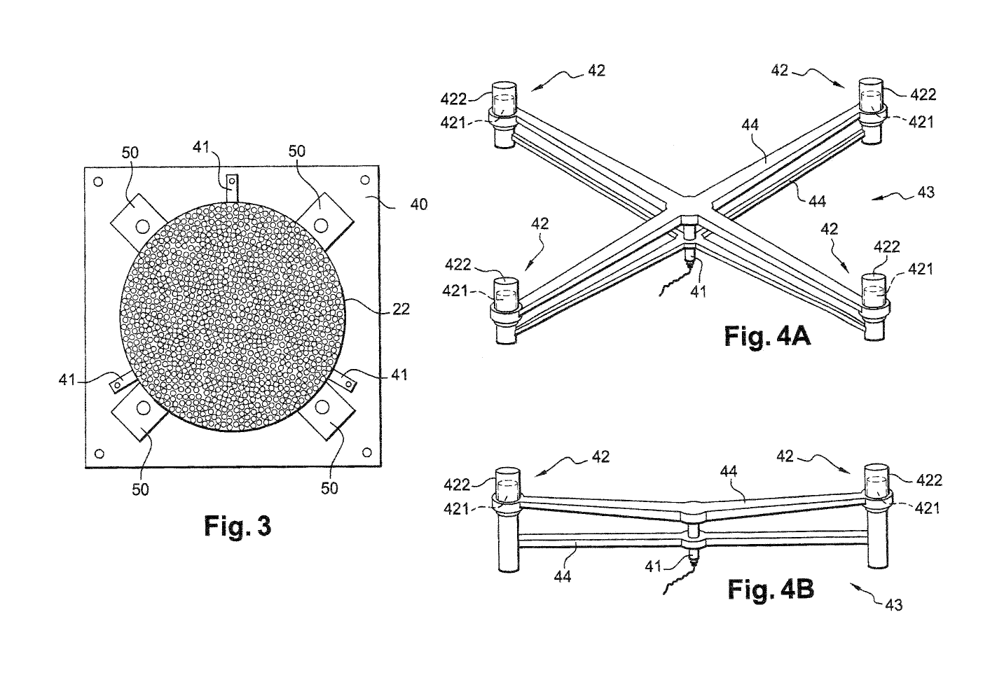

FIG. 3: a sectional view, according to a horizontal plane, of a metabolic cage fitted with 4 modules 50 and laid on an actimetry platform 40 including 3 motion and weighing sensors 41 arranged as a triangle,

FIG. 4A: a perspective view of a general purpose actimetry chassis 43 intended for receiving a metabolic cage according to the invention or any cage.

FIG. 4B: the chassis 43 of FIG. 4A, represented as a sectional view, according to a vertical plane,

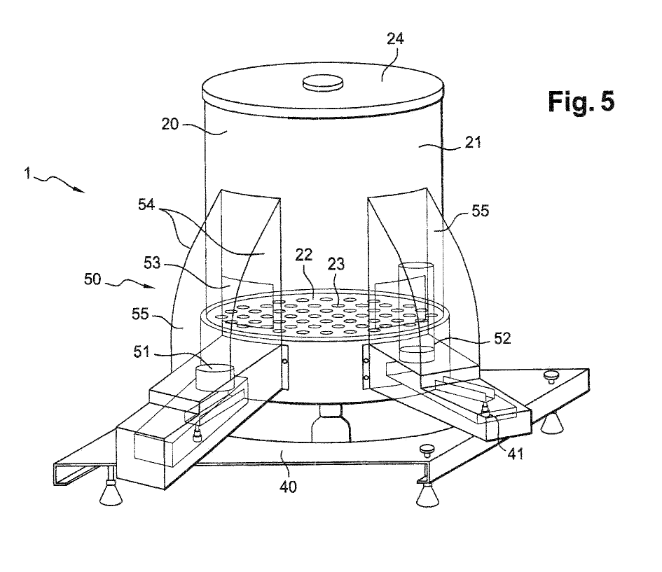

FIG. 5: a general view of a metabolic cage 1, including two modules 50,

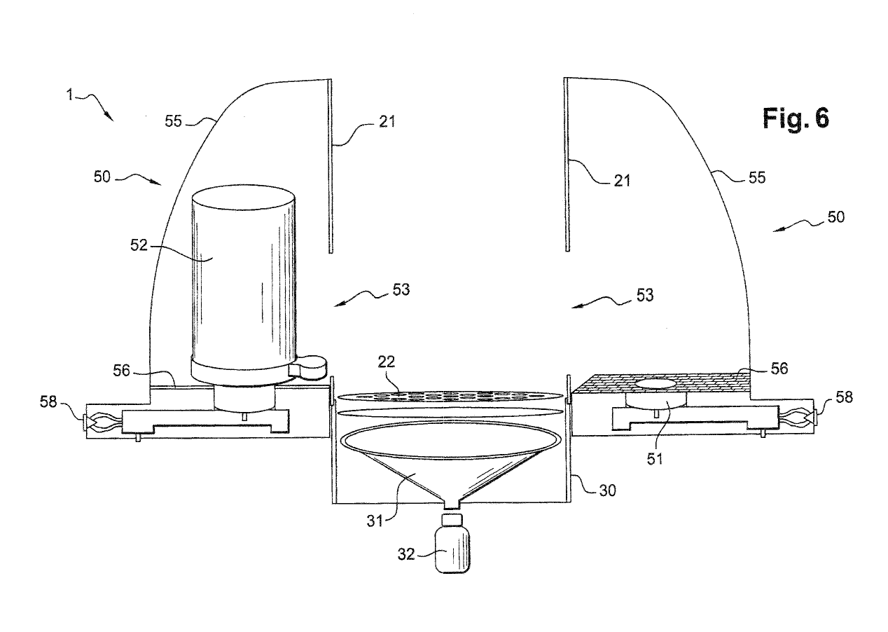

FIG. 6: a sectional view, according to a vertical plane, of the metabolic cage 1 represented on FIG. 5,

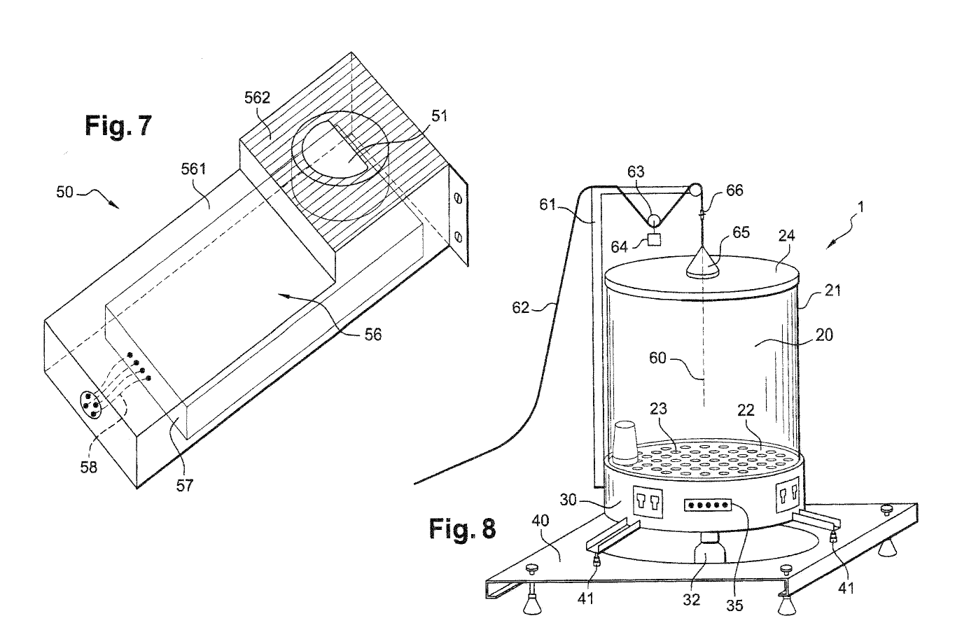

FIG. 7: a detail view of FIG. 5, representing the lower portion of a module 50,

FIG. 8: a general view of a metabolic cage 1, according to the invention, including a living chamber 20, a technical mount 30, an actimetry platform 40, and a cable 60 supported by a gantry 61 and balanced by a pulley 63 and counterweight 64 system.

FIG. 9: a general view of a metabolic cage 1, according to the invention, including a living chamber 20, closed by a removable roof (24) here fitted with a fan (241) and of a means for evacuating vitiated air (242), a rackable technical mount (30), fitted with two modules 50, and an actimetry platform (40), fitted with 4 feet. The actimetry platform is fitted with several load or weighing sensors (41). In this configuration it is possible to perform multi-parameter studies, i.e. measure respiratory exchanges, food intake, water intake and the displacements of the animal. By relocating the feet directly under the technical mount (30) it is also possible work without the actimetry platform.

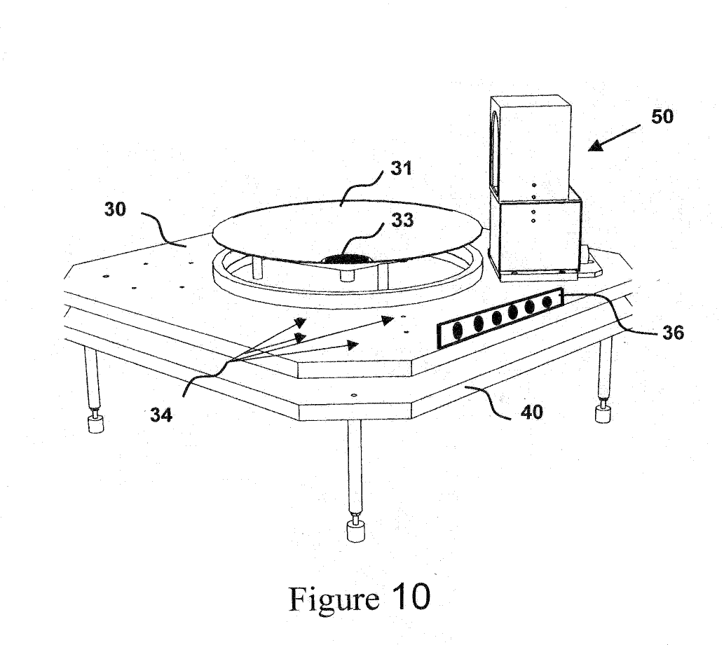

FIG. 10: a view of the technical mount (30) with its funnel (31) and sieve (33) for collecting and separating urines and faeces, whereon are visible the accommodation zones of the modules 50 (34), and fitted with an implementation module (50) and laid on a rest 40. On this mount there is also a technical plate pour the electric and hydraulic connections (36).

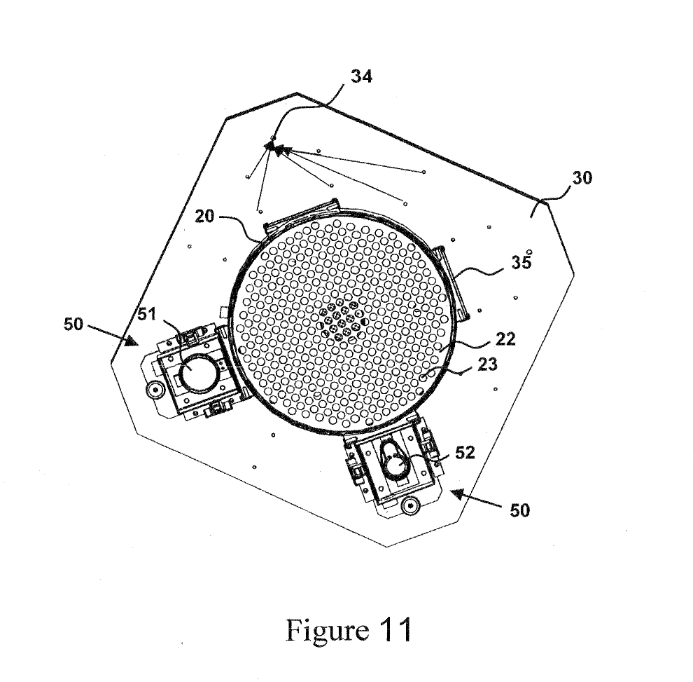

FIG. 11: top view in a horizontal plane of a metabolic cage (20) equipped with its floor (22) fitted with honeycombs (23) and laid on a technical mount (30) fitted with two modules 50. On this figure the location of the modules 50 and of the gantries (34) as well the sliding doors (35) closing the apertures of the living chamber are presented.

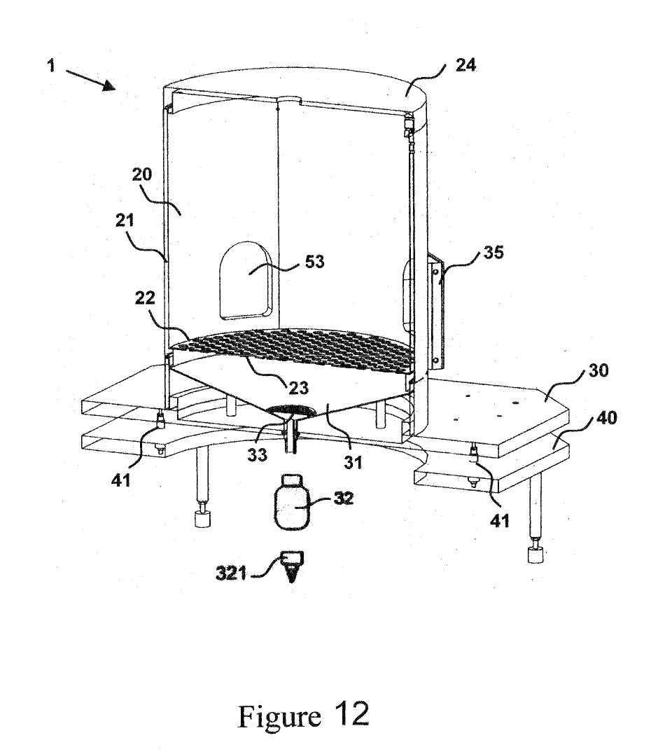

FIG. 12: sectional view in a vertical plane of a metabolic cage 1, closed by a lid (24), fitted with its technical mount (30), the assembly on an actimetry platform 40 equipped with load sensors (41). On this figure the honeycomb floor (22-23), the funnel (31) and the sieve for retaining faeces (33) are also represented. The urines may be collected in a vessel (32) or using a connector (321) fixed to a tube extending towards a refrigerated vessel or a fraction collector.

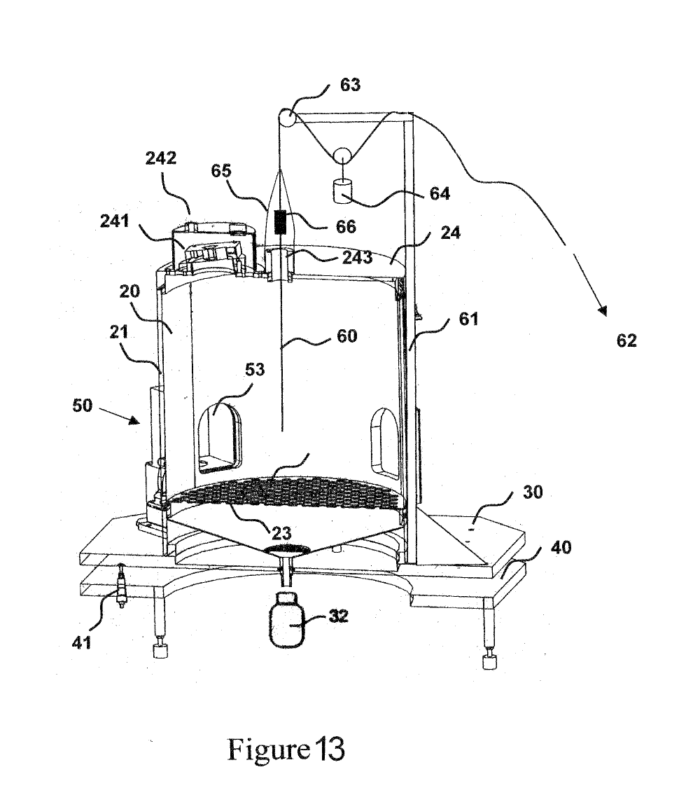

FIG. 13: same view represented on FIG. 5 of the metabolic cage 1, fitted with a module (50), a gantry (61) fitted with a cable (60) balanced by a pulley (63) and counterweight (64) system. In this figure the cage is set up to enable recording respiratory exchanges. The inlet of the cables is made leak-proof by a flexible sleeve (65) closed on the cable and the cable bushing (43). The lid (24) is fitted with a fan (241) and an outlet for extracting vitiated air (242).

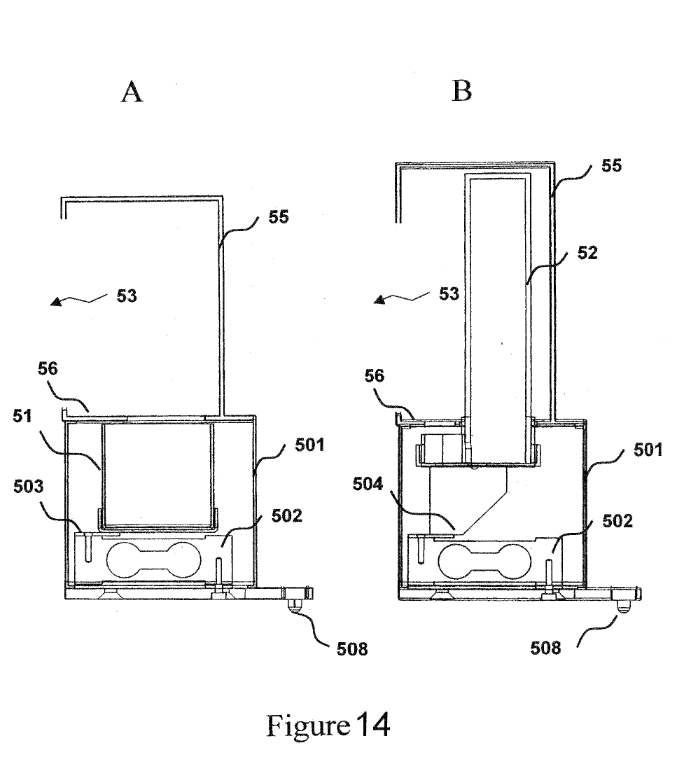

FIG. 14: lateral sectional view of a module 50 fitted for measuring the food intake (7a) and a module fitted for measuring the water intake (7b) Preferably the module is fitted with a measuring sensor (502), a trough rest (503) and a trough (505) or a feeding-bottle rest (504) and a feeding-bottle (506), a protective box (501) and a preferably transparent cover (507) overlaying the protective box and enable access from the living chamber. In an “all purpose” configuration, any type of technical element may be integrated in the module (50). An empty module (50) of suitable size may also be used as a recess for improving the comfort of the animal and enable a behaviour closer to the conditions in the wild.

In the following description as well as on the drawings and by reasons of concision and clarity, the same reference numbers are used to designate identical members or objects enabling the implementation of the method object of the invention.

The metabolic cage (1) for small rodents, object of the invention, represented diagrammatically on FIG. 1, includes a living chamber (20) designed to receive a rodent, said living chamber (20) including side walls (21) and a floor (22) fitted with honeycombs (23) enabling the evacuation of urines and faeces by gravity, and
a technical mount 30 including a funnel (31) intended for receiving and directing said urines and faeces toward a vessel (32),
   said living chamber 20 and said technical mount (30) each comprising complementary nesting elements, enabling the living chamber (20) to be assembled and released relative to the technical mount (30).

In other words, said metabolic cage (1) includes a first functional position wherein the technical mount (30) is in contact with the living chamber (20) (FIGS. 1 and 9) and a second functional position wherein the technical mount (30) is separated from the living chamber (20) (FIGS. 2 and 10).

Alternately, the vessel (32) may be replaced with a connector (321) and a tube associated with a pump and with a fraction collector enabling sequential sampling of urines and/or its collection in a refrigerated vessel (FIG. 12).

Said technical mount (30) also comprises at least one supporting part intended for receiving a module (50) useful to the implemented of the metabolic cage (1), in particular for phenotyping of the small rodents (FIG. 1). In the embodiment of FIG. 10, the technical mount (30) includes an accommodation or supporting zone (34) intended for receiving a module (50) for implementing the metabolic cage (1). In this embodiment, the accommodation or supporting zone (34) of the mount (30) may include a technical plate (36) of the gantry type supporting the electric and/or hydraulic cables liable to be connected to the animal.

Preferably, the technical mount 30 includes 1, 2, 3 or 4, supporting parts (34, FIG. 1) or 1, 2, 3 or 4 supporting parts of accommodation zone type (34, FIG. 10). Any of these rests (34) may be used for attach an implementation module (50) (FIGS. 5, 10) and/or a gantry (61, FIGS. 8, 13).

By way of example, as represented on FIGS. 1 and 11, the technical mount (30) includes two supporting parts (34, FIG. 1), or two accommodation or supporting zones (34, FIG. 11) each intended for receiving a module (50).

The technical mount (30) may be fitted with an electric supply device, for instance a technical plate (35, FIG. 8) or a technical plate of the gantry type (35, FIG. 10) enabling to bring electrical current inside the technical mount (30), for the centralised electric connections, for instance for supplying one or several small apparatuses such as a fan (241, FIGS. 9, 13).

The side walls (21) of the living chamber form a cylinder, so that the volume available for the animal is maximal.

Preferably, the living chamber (20) includes a ceiling (24). In certain cases, this ceiling may be fixed leak-proof on the living chamber (20). The living chamber (20), or the ceiling (24), may be fitted with a fan (241). Said fan (241) may be associated with a thermoregulation system, for ensuring the accurate control of the temperature of the living chamber (20).

As it appears more clearly on the portion of the technical mount (30) represented on FIGS. 2, 10 and 12, a second mesh or sieve (33), may be placed in the technical mount (30), within the funnel (31), so as to separate the urines and faeces of the small rodent. In a preferred manner, this second mesh or sieve (33) is formed of stainless steel.

In a preferred manner, the lateral walls 21 of the living chamber are formed of a transparent matter, washable and which may be sterilised, using chemical agents.

The floor (22) may be a plate of stainless steel drilled with honeycombs (23), or consist of some mesh suitable for the comfort and safety of the animal, for instance of stainless steel.

Preferably, the funnel (31) intended for receiving the urines and the faeces, is also formed of stainless steel, or of a hydrophobic material such as Teflon®. The funnel (21) possesses advantageously a very smooth surface, for correct flow of urines.

Alternately, the members liable of being in contact with the animal or body fluids of the animal may be formed of ceramic, so as to prevent corrosion. Thus, the funnel (31), the vessel (32), intended for collecting the urines and the faeces or still the floor (22) of the living chamber (20) may be formed of ceramic, of glass or of plastic materials compatible with the biological fluids.

The technical mount (30) may be formed of any matter, washable in a dish-washer, and autoclavable for the metallic members.

In a preferred embodiment of the invention, the metabolic cage (1) may include, moreover, an actimetry platform (40) placed in contact with the technical mount (30), said actimetry platform (40) including at least one motion sensor (41), preferably a sensor for detecting the loads applied to the platform. The actimetry platform (40) represented on FIGS. 1 and 3 possesses 3 piezoelectric load sensors (41).

By way of example, the technical mount (30) and/or the actimetry platform (40) may be square in shape, so as to be able to locate several metabolic cages (1) in racks.

In a particular embodiment of the invention, the technical mount (30) rests on the chassis (43) represented on FIG. 4. This chassis (43) rests on four rests (42) connected together by four arms (44) forming a “X” in the centre of which is placed a single motion sensor (41).

The rests (42) may be composed of a piston (421) sliding in a chamber (422), so as to ensure the stability of the chassis (43).

This simplified embodiment, wherein the number of motion sensors is reduced to a single sensor (41), enables to decrease the cost of the actimetry platform (30), while enabling to perform a set of complex measurements on the studied rodent such as the measurement of its physical activity or sleep control. This actimetry platform (30) may also be used solely with animal-room standard living cages.

By way of example, sensors capable of resisting a 50-kg mass may be used, enabling to detect variations in load of 0.1 g or still sensors capable of resisting a 25-kg mass, enabling to detect variations in load of 0.05 g. More especially for the measurements of motive activity of the animal, other types of sensors, for instance less costly, may be used, such as for example weighing bars.

The metabolic cage (1) may include moreover at least one module (50) forming an internal volume communicating with the volume formed by the living chamber (20), so that a rodent placed in the living chamber (20) may access said module (50). A metabolic cage (1), including two modules (50) is represented on FIGS. 5, 9 and 11.

FIGS. 3 and 11 represent a top view of two standard embodiments of the metabolic cage (1), wherein the metabolic cage (1) includes four modules (50, FIG. 3) or two modules (50, FIG. 11). Said module (50) may include a solid or liquid food reserve. This food reserve may be a trough (51, FIGS. 5, 6, 11, 14A) or a feeding-bottle (52, FIGS. 5, 6, 11, 14B).

FIGS. 6, 12, 13 represent each a sectional view of a metabolic cage (1), including two modules (50), the first one is fitted with a trough (51), and the second module (50) includes a feeding-bottle (52).

The module (50) forms a volume open to the living chamber (20), thanks to an opening (53) performed in the wall (21) of the living chamber (20).

When the module (50) includes a trough (51) or a feeding-bottle (52), the opening (53) will have preferably sufficiently large a surface so that the rodent may insert its head through the opening, and thus reach the trough (51) or the feeding-bottle (52), but sufficiently narrow to avoid the dispersion of the food by the animal and prevent the animal from resting on the trough or the feeding-bottle of the module (50).

Alternately or simultaneously, the metabolic cage (1) may include an empty module (50), i.e. deprived of trough or de feeding-bottle, said module (50) communicating with the living chamber (20) with sufficiently large an opening so that the rodent may enter the module (50), so that for instance the latter may have a rest therein. The module (50) then forms a recess for the rodent.

The module (50) may also include other elements such as a switch or more generally a control device, that the rodent may actuate itself.

By way of example, as represented on FIG. 6, the module (50) may include a floor (56) designed to receive a feeding-bottle (52) or a trough (51), situated flush with the floor (22) of the living chamber (20), two side walls (54) vertical, (FIG. 5) and a rear wall (55), in contact with the living chamber (20), so as to form a closed space with the living chamber (20).

Also by way of example, as represented on FIG. 14, the module 50 may include a box intended for housing the measuring sensor (502), the trough (503) or feeding-bottle (504) rest and having elements (508) necessary to the attachment thereof on the accommodation zones of the technical mount. The box is overlaid with a cover (55), preferably transparent so as to form a closed space after contacting the module 50 with the living chamber.

Finally, an opening (53), is provided between the module (50) and the living chamber (20).

Optionally, the opening (53) may be sealed by a diaphragm or a sliding wall which may be motorised so as to program automatic opening and/or closing operations.

A closing system of the openings (53) may also be provided, so that the openings (53) are inoperative when the metabolic cage (1) is in the second functional position wherein the technical mount (30) is separated from the living chamber (20).

In the case of a tight assembly, for instance for measuring respiratory exchanges, the tightness of the space formed by the association of the living chamber (20) with the module (50) is ensured by seals situated on the edges of the side (54) and rear (55) walls of the module (50), in contact with the living chamber (20) (FIG. 5). In other embodiments, seals are situated between the walls (55) and interface plates (35) of the living chamber (20) (FIGS. 11 and 12).

Preferably, the metabolic cage (1) includes 1 to 4 modules (50).

In the embodiment presented on FIG. 11, the metabolic cage (1) includes two modules (50), but have two additional rests (34) for attaching four modules (50) in total.

FIGS. 5 and 12 represent the details of modules (50) including a trough (51) or a feeding-bottle (52).

FIG. 7 represents in detail a module (50) including a trough (51). The floor (56) of the module (50), is composed of a rear part (561), intended for housing the weighing sensor (57), or an inert rest, and a front part (562), including the trough (51), intended for housing the head of the rodent.

Optionally, the module (50) may include a sensor (57) enabling to measure the mass of food contained in the trough (51). As visible on FIG. 7, the sensor (57) includes connection means (58), which communicate with the outside of the module (50).

FIG. 14 represents, according to another embodiment, the detail of a module (50) including a trough (14A) or a feeding-bottle (14B). The trough and the feeding-bottle are protected by a floor (56) wherein is provided a hole enabling access to food or water. The box (501) of the module (50) is fitted with a device (508) for attachment to the accommodation zones (34) of the technical mount (30). Optionally it encloses a sensor (502) whereon is attached the trough (503) or the feeding-bottle (504).

In a particular embodiment of the invention, the living chamber (20) may be made proof to fluids, liquids, gas, or both, in particular thanks to the use of a ceiling (24).

When the living chamber (20) is made proof, the latter may be fitted with a device for measuring exchanges, in particular gaseous fluids, more particularly respiratory exchanges.

This device for measuring respiratory exchanges, whereof an embodiment is represented in particular on FIG. 13, includes:
a fresh air supply means, preferably situated on the lower part of the living chamber (20),
one or several fans (241) situated in the metabolic cage (1) and/or in the modules (50)
a means for evacuating vitiated air (242),
a means for measuring the ratio of O₂ and/or of CO₂ in vitiated air, and
a means for measuring the air flow through the metabolic cage (1).

The means for supplying fresh air and evacuating vitiated air are for instance formed each of a tube connected to a pump.

By way of example, the means for measuring the ratio of CO₂ in vitiated air is composed of analysis cells of O₂ and of the CO₂, branching off on the tubes for supplying fresh air and evacuating vitiated air.

Such a measuring device enables to know the energetic balance of the rodent placed in the living chamber.

The metabolic cage (1) described above may also be fitted with the optional equipment described below, which enable the user to adapt the metabolic cage (1) to its needs.

For instance, the funnel (31) contained in the technical mount (30) may be fitted with a moisturising device including a rinsing means. A moisturising device enables to prevent the evaporation of the small quantities of urine produced by the rodents situated in the living chamber.

Optionally, when the metabolic cage (1) is deprived of an actimetry platform (40), a device for controlling the position of the small rodent in the living chamber (20) by infrared beam may be added to the living chamber (20). Such a system is quite conventional for the man of the art and hence will not be described in detail.

In a particular embodiment of the invention, represented on FIGS. 8 and 13, the metabolic cage (1) includes one or several hydraulic and/or electric cables (60), situated above the living chamber (20), said cable(s) (60) being intended to provide different measurements or to provide infusions or samplings on the small rodent.

The cable (60) is connected to a gantry (61) attached to the technical mount (30) by the supporting parts (34), and the back-and-forth movements induced by the activity of the animal are compensated for by a pulley (63) fitted with a counterweight (64) adapted to the weight of the cable(s) (60).

Moreover, the ceiling (24) may include a bore enabling the passage of the cable(s) (60) inside the living chamber (20) (FIGS. 8 and 13). On FIG. 13, a suitable cable bushing (243) is also represented.

In case when the metabolic cage (1) must remain leak-proof, a sealing sleeve (65) may be fixed between the cable(s) (60) and the lid (24) (FIG. 8) or between the cable(s) (60) and the cable bushing (243) (FIG. 13).

The cable(s) (60) may be connected, via the means (62), to devices for blood sampling, for instance a syringe, or still micro-dialysis devices or devices for delivering exogenous substances, or instance physiologically active compounds to be tested.

Alternately, the cable(s) (60) may be connected to a source of energy so as to produce electric stimulations of the rodent or to intra or extra cellular recorders.

The cable(s) (60) may moreover include a hydraulic and/or electrical revolving joint (66) (FIGS. 8 and 13).

The invention also relates to a method for phenotyping a rodent, including the following steps:
a) placing a rodent in a living chamber 20 of a metabolic cage (1), said living chamber (20) including side walls (21) and a floor (22) fitted with honeycombs (23) enabling the evacuation of urines and faeces by gravity,
b) placing the living chamber (20) in a functional position wherein the floor (22) of the living chamber (20) is separated from a technical mount (30) including a funnel (31) intended for receiving and separating said urines and faeces, via a sieve (33) and for directing the urines towards a vessel (32) and,
c) placing the living chamber (20) in a functional position wherein the floor (22) of the living chamber (20) is in contact with said technical mount (30), so as to be able to perform the phenotyping of the rodent.

1. A metabolic cage (1) for small rodents including:
a living chamber (20) designed to receive a rodent, said living chamber (20) including side walls (21) and a floor (22) fitted with honeycombs (23) enabling the evacuation of urines and faeces by gravity, and
a technical mount (30) including a funnel (31) intended for receiving and separating said urines and faeces toward a vessel (32),
characterised in that said living chamber (20) and said technical mount (30) each comprise complementary nesting elements, enabling the living chamber (20) to be assembled and released relative to the technical mount (30).

2. A metabolic cage (1) according to claim 1, characterised in that it comprises moreover, an actimetry platform (40) situated in contact with the technical mount (30), said actimetry platform (40) including at least one sensor selected among a motion sensor (41), a load sensor and a weighing sensor

3. A metabolic cage (1) according to claim 1, characterised in that it comprises moreover at least one module, (50) whereof one of the side walls (21) enables communication with the volume formed by the living chamber (20), so that a rodent placed in said living chamber (20) may access said module (50)

4. A metabolic cage (1) according to claim 3, characterised in that said module (50) and said living chamber (20) are separated from a sealable opening (53).

5. A metabolic cage (1) according to claim 3, characterised in that it comprises 1 to 6 modules (50), advantageously 1 to 4 modules (50), and preferably 1 or 2 modules (50).

6. A metabolic cage (1) according to claim 1, characterised in that the living chamber (20) includes a ceiling (24).

7. A metabolic cage (1) according to claim 6, characterised in that it comprises moreover a device for measuring respiratory exchanges.

8. A metabolic cage (1) according to claim 7, characterised in that said device for measuring respiratory exchanges includes successively:
a fresh air supply means,
one or several fans situated in the metabolic cage (1), and/or in the ceiling (24) and/or in the modules (50),
a means for evacuating vitiated air,
a means for measuring the ratio of O₂ and/or de CO₂ in vitiated air, and
a means for measuring the air flow through the metabolic cage (1).

9. A metabolic cage (1) according to claim 1, characterised in that the funnel (31) is fitted with a moisturising device including a means for rinsing said funnel.

10. A metabolic cage (1) according to claim 1, characterised in that it comprises moreover one or several hydraulic and/or electric cables (60), which may reach into the living chamber (20), said cable(s) (60) being intended for taking measurements on the small rodent or for performing infusions or samplings.

11. A metabolic cage (1) according to claim 2, characterised in that it comprises moreover at least one module, (50) whereof one of the side walls (21) enables communication with the volume formed by the living chamber (20), so that a rodent placed in said living chamber (20) may access said module (50)

12. A metabolic cage (1) according to claim 4, characterised in that it comprises 1 to 6 modules (50), advantageously 1 to 4 modules (50), and preferably 1 or 2 modules (50).

13. A metabolic cage (1) according to claim 2, characterised in that the living chamber (20) includes a ceiling (24).

14. A metabolic cage (1) according to claim 2, characterised in that the funnel (31) is fitted with a moisturising device including a means for rinsing said funnel.
